(19) United States
(12) Patent Application Publication
(10) Pub. No.: US 2009/0012902 A1
(43) Pub. Date: Jan. 8, 2009

(54) METHOD AND APPARATUS FOR PROVIDING A SUPPLEMENTARY PRODUCT SALE AT A POINT-OF-SALE TERMINAL

(76) Inventors: Dean P. Alderucci, Stamford, CT (US); Andrew S. Van Luchene, New York, NY (US)

Correspondence Address: WALKER DIGITAL MANAGEMENT, LLC, 2 HIGH RIDGE PARK, STAMFORD, CT, 06905, US

(21) Appl. No.: 11/927,932

(22) Filed: Oct. 30, 2007

Related U.S. Application Data
(62) Division of application No. 09/933,588, filed on Aug. 21, 2001.
Application No. 09/933,588 is a continuation-in-part of application No. 09/045,347, filed on Mar. 20, 1998, now abandoned.
Application No. 09/045,347 is a continuation-in-part of application No. 08/920,116, filed on Aug. 26, 1997, now Pat. No. 6,119,099.
Application No. 08/920,116 is a continuation-in-part of application No. 08/822,709, filed on Mar. 21, 1997, now Pat. No. 6,267,670.

(51) Int. Cl. G06Q 30/00; G06Q 10/00

(52) U.S. Cl. 705/80; 705/20; 705/400; 705/30

(57) ABSTRACT

A POS terminal provided in accordance with the present invention receives the items in a purchase. Typically, each item will have a bar code that is scanned by a bar code scanner, and the POS terminal in turn receives, from the bar code scanner, signals representative of the items. The POS terminal then determines an upsell based on the items, and a rounded price that the customer may pay for both the items and the upsell. The rounded price may be determined by rounding up the purchase price to a predetermined multiple, such as to the next higher dollar amount. The customer is provided with an offer to exchange the items and the upsell(s) for the rounded price, and the customer in turn responds to the offer. If the response indicates acceptance of the offer, the items and the upsell are exchanged for the rounded price. If necessary, the POS terminal makes appropriate adjustments to stored indications of available quantities of items to reflect that the items and upsell(s) have been sold.

### CROSS-REFERENCE TO RELATED APPLICATIONS

This application is a divisional of U.S. application Ser. No. 09/933,588 entitled METHOD AND APPARATUS FOR PROVIDING A SUPPLEMENTARY PRODUCT SALE AT A POINT-OF-SALE TERMINAL filed Aug. 21, 2001; which is a continuation of U.S. patent application Ser. No. 09/933,588 entitled METHOD AND APPARATUS FOR PROVIDING A SUPPLEMENTARY PRODUCT SALE AT A POINT-OF-SALE TERMINAL filed Aug. 21, 2001.

U.S. patent application Ser. No. 09/933,588 is a continuation-in-part application of each of the following applications:

(i) U.S. patent application Ser. No. 09/045,347 entitled METHOD AND APPARATUS FOR PROVIDING A SUPPLEMENTARY PRODUCT SALE AT A POINT-OF-SALE TERMINAL, filed on Mar. 20, 1998 and now abandoned; which is a continuation-in-part of U.S. patent application Ser. No. 08/920,116, entitled METHOD AND SYSTEM FOR PROCESSING SUPPLEMENTARY PRODUCT SALES AT A POINT-OF-SALE TERMINAL, filed Aug. 26, 1997 and issued as U.S. Pat. No. 6,119,099 on Sep. 12, 2000; which in turn is a continuation-in-part of U.S. patent application Ser. No. 08/822,709, entitled SYSTEM AND METHOD FOR PERFORMING LOTTERY TICKET TRANSACTIONS UTILIZING POINT-OF-SALE TERMINALS, filed on Mar. 21, 1997 and issued as U.S. Pat. No. 6,267,670 on Jul. 31, 2001;
(ii) U.S. patent application Ser. No. 09/603,677, filed Jun. 26, 2000 and entitled METHOD AND APPARATUS FOR SELECTING A SUPPLEMENTAL PRODUCT TO OFFER FOR SALE DURING A TRANSACTION;
(iii) U.S. patent application Ser. No. 09/045,518, filed Mar. 20, 1998 and issued as U.S. Pat. No. 7,072,850 on Jul. 5, 2006 and entitled METHOD AND APPARATUS FOR PROCESSING A SUPPLEMENTARY PRODUCT SALE AT A POINT-OF-SALE TERMINAL;
(iv) U.S. patent application Ser. No. 09/083,689, filed May 21, 1998 now abandoned and entitled METHOD AND SYSTEM FOR SELLING SUPPLEMENTAL PRODUCTS AT A POINT-OF-SALE;
(v) U.S. patent application Ser. No. 09/076,409, filed May 12, 1998 and issued as U.S. Pat. No. 6,298,329 on Oct. 2, 2001 and entitled METHOD AND APPARATUS FOR GENERATING A COUPON;
(vi) U.S. patent application Ser. No. 09/777,297, filed Feb. 6, 2001 now abandoned and entitled METHOD AND APPARATUS FOR CONTROLLING OFFERS THAT ARE PROVIDED AT A POINT-OF-SALE TERMINAL, which is a continuation of U.S. Pat. No. 6,223,163 B1, issued on Apr. 24, 2001 and entitled METHOD AND APPARATUS FOR CONTROLLING OFFERS THAT ARE PROVIDED AT A POINT-OF-SALE TERMINAL; and
(vii) U.S. patent application Ser. No. 09/083,483, filed May 22, 1998 and issued as U.S. Pat. No. 6,298,331 on Oct. 2, 2001 and entitled METHOD AND APPARATUS FOR SELLING AN AGING FOOD PRODUCT. Each of the above referenced applications is incorporated by reference herein in its entirety.

The present invention is also related to the following U.S. patent applications:

U.S. patent application Ser. No. 09/045,084, entitled METHOD AND APPARATUS FOR CONTROLLING OFFERS THAT ARE PROVIDED AT A POINT-OF-SALE TERMINAL, and issued as U.S. Pat. No. 6,223,163 B1 on Apr. 24, 2001; U.S. patent application Ser. No. 09/045,036, entitled METHOD AND APPARATUS FOR FACILITATING THE PLAY OF FRACTIONAL LOTTERY TICKETS UTILIZING POINT-OF-SALE TERMINALS; U.S. patent application Ser. No. 09/045,386, entitled METHOD AND APPARATUS FOR CONTROLLING THE PERFORMANCE OF A SUPPLEMENTARY PROCESS AT A POINT-OF-SALE TERMINAL; U.S. patent application Ser. No. 09/045,518, issued as U.S. Pat. No. 7,072,850 on Jul. 4, 2006 entitled METHOD AND APPARATUS FOR PROCESSING A SUPPLEMENTARY PRODUCT AT A POINT-OF-SALE TERMINAL; and U.S. patent application Ser. No. 09/083,689, now abandoned, entitled METHOD AND SYSTEM FOR SELLING SUPPLEMENTAL PRODUCTS AT A POINT-OF-SALE TERMINAL, each assigned to the assignee of the present invention and incorporated by reference herein.

### FIELD OF THE INVENTION

The present invention is also related to U.S. patent application Ser. No. 11/773,274, entitled METHOD AND APPARATUS FOR CONTROLLING OFFERS THAT ARE PROVIDED AT A POINT-OF-SALE TERMINAL, filed Jul. 3, 2007.

The present invention relates to point-of-sale terminals, and more specifically to point-of-sale terminals that provide offers for supplementary products.

### BACKGROUND OF THE INVENTION

Point-of-sale (“POS”) terminals, such as cash registers, are used in a wide variety of businesses for performing such processes as calculating the total price of a purchase (good or service) and calculating the amount of change due to a customer. Depending on their level of sophistication, such POS terminals may be further useful in performing related functions such as inventory management by tracking purchases made and adjusting a database of store inventory accordingly. In addition, POS terminals may be used with and/or function as an offering system.

An upsell, as used herein, is a product (good or service) which is offered along with a purchase. Types of upsells include (i) an upgrade from a first product to a second product different from the first product, (ii) an additional product, (iii) a voucher which is redeemable for a product or a discount thereon, and (iv) an entry in a sweepstakes, contest, lottery or other game. A customer may be offered an upsell in exchange for an amount of change he is due. The amount of change a customer is due may be calculated in various ways. For example, a customer purchasing a first product for $1.74 may be offered a second product in exchange for $0.26 (the change due if the customer tenders $2.00). Various other types of upsells will be apparent to those of skill in the art, and may be used without departing from the scope and spirit of the present invention.

Many different criteria may be used in determining an upsell. For example, U.S. Pat. No. 6,119,099 discloses that a POS terminal may calculate the purchase price, and round the purchase price to, e.g., the nearest dollar, nearest quarter, or nearest five dollars to generate a round-up (change) amount. The POS terminal in turn determines which of a plurality of upsells may be profitably exchanged for the round-up amount.

It would be advantageous to provide other methods of determining upsells. It would be particularly advantageous to provide a method and apparatus for determining an upsell which personnel, such as a store manager or POS terminal operator, may easily understand and adjust.

### SUMMARY OF THE INVENTION

It is an object of the present invention to provide a method and apparatus for determining an upsell. The method and apparatus comprises a point-of-sale system that is operable to determine an upsell to offer to a customer based on a record in a database accessible by the point-of-sale system.

In accordance with the present invention, a POS terminal receives an indication of at least one item in a purchase. The POS terminal then determines an upsell based on the at least one item by accessing a database of available upsells and determining the upsell that corresponds to the at least one item as indicated by a record in the database. The POS terminal then determines a rounded price that the customer may pay for both the at least one item and the upsell and provides an offer to exchange the at least one item and the upsell for the rounded price.

### BRIEF DESCRIPTION OF THE DRAWINGS

FIG. 1 is a schematic illustration of a POS terminal provided in accordance with the present invention.

FIG. 2 is a schematic illustration of another embodiment of the POS terminal of FIG. 1.

FIG. 3 is a schematic illustration of an inventory database of the POS terminal of FIG. 1.

FIG. 4 is a schematic illustration of a possible upsells database of the POS terminal of FIG. 1.

FIG. 5 is a schematic illustration of an embodiment of an upsell offer database of the POS terminal of FIG. 1.

FIG. 6 is a schematic illustration of another embodiment of the upsell offer database of the POS terminal of FIG. 1.

FIG. 7 is a schematic illustration of another embodiment of the upsell offer database of the POS terminal of FIG. 1.

FIG. 8 is a schematic illustration of another embodiment of the upsell offer database of the POS terminal of FIG. 1.

FIG. 9 is a flow chart illustrating a method for providing a supplementary product sale at a POS terminal.

FIG. 10 is a schematic illustration of another embodiment of an upsell offer database.

FIG. 11 is a schematic illustration of another embodiment of an upsell offer database.

FIG. 12 is a schematic illustration of another embodiment of an upsell offer database.

FIG. 13A is a flow chart illustrating a method for generating data for use in a supplementary product sale.

FIG. 13B is a flow chart illustrating a method for generating data for use in a supplementary product sale.

### DETAILED DESCRIPTION OF THE PREFERRED EMBODIMENTS

A method and apparatus are provided whereby an upsell to offer to a customer is determined from the items in his purchase, according to predefined relationships. Such relationships between items in a purchase and upsells to offer may be described conceptually by a table that includes both the items and the upsells. The table, in turn, describes a corresponding database defining upsells to offer when a customer's purchase consists of particular items.

Such a table-based embodiment is particularly easy for a typical store manager or other knowledgeable person to understand. For example, a store manager of a fast-food restaurant might desire to see what upsells could be offered to a customer that orders a hamburger and small French fries. The store manager may search the table for entries that correspond to a hamburger and small French fries, and then determine corresponding upsells from those entries.

Such a table-based embodiment is also easy for a typical store manager or other knowledgeable person (e.g., a consultant, regional manager, productivity expert) to adjust as necessary. For example, a store manager might determine that a significant number of customers who order a hamburger and small French fries would also find a dessert appealing. The store manager could then adjust the table (which represents a database) to include an entry (i.e. record) which defines a dessert upsell for purchases that consist of a hamburger and small French fries. The ability to make changes in such a database by informed and authorized personnel and have these changes effect transactions with customer served by various cashiers is advantageous. Customers in stores and quick service restaurants are typically served by cashiers and other people with minimal training and minimal knowledge of the costs and profitability considerations factored into the items being sold. Therefore, although it would be beneficial at times to enable a cashier to offer discounts or other offers to customers, cashiers cannot be completely entrusted with such a function due to their limited information and training. On the other hand a store manager and others who typically can make an informed decision cannot be there to interact with every customer. Therefore, enabling the manager to make a centralized decision and control the items being offered as upsells via the multiple point of sale terminals throughout the store is a benefit of the present invention.

In one embodiment of the present invention personnel are assigned authorization codes that authorize the personnel to make changes to upsells in a database. For example, if a store manager wants to change the upsell that corresponds to a purchase of French fries and a hamburger from an apple pie to a soft drink, he would first enter his authorization code in order for the system to accept his changes. There may be various levels of authorization built into the system as well. For example, certain personnel may be authorized to make more substantial changes to the upsell database (e.g. permanently change what upsell will be offered with a certain purchased item) while others may only be authorized to make more limited changes (e.g. to make an upsell temporarily unavailable for offers due to low inventories). Such varying levels of authorization may be desirable to differentiate between personnel that have more training, knowledge, and/or responsibility regarding a business (e.g. between a regional manager and a local store manager). In such an embodiment the system may store a table of authorization codes and optimally a list of corresponding changes that the holder of the authorization code is permitted to make. Thus, before implementing a change in the upsell database, the system would receive an authorization code and determine whether the requested change is of a type permitted by the authorization code.

Of course the entries in the database of upsells corresponding to purchased items do not have to be manually entered by store personnel. The determination of what upsells to offer with which items may be made by a completely or partially automated process based on, for example, criteria input by store or other authorized personnel or on previous offer acceptance and rejection data. Similarly, upsells that are manually entered as corresponding to specific items purchased may subsequently be adjusted in an automated fashion. Such adjustment may be based on, for example, the success rate of offering a certain upsell. For example, if a manager enters “apple pie” as the upsell to offer for orders containing a hamburger, drink, and French fries and the acceptance rate for this upsell is very low, the system may adjust the upsell for that order to be another dessert (e.g. cookies). Such an adjustment may be performed based on an alternative upsell entered by the manager or based on rules in the system that categorize items (e.g. both apple pie and cookies are categorized as a dessert and may therefore be substituted for one another).

Further, upsells may be entered into or adjusted in a database by remote personnel. For example, if the local store is owned by a corporation whose headquarters are remote from the local store, the personnel at the remote headquarter may be able to access the database from the remote location. The local store manager, in such an embodiment, may have limited access to adjust the entries made by the remote personnel. For example, the store manager may be authorized to select an upsell for a given order that should be offered based on, for example, current inventories or weather conditions. Of course methods other than authorization codes may be utilized to allow changes to be made to the upsell database only by certain personnel. For example, a computer with an interface that allows such changes to be made may be stored in a location to which only such personnel have access (e.g. in a locked manager's office).

Since upsells are exchanged for a round-up amount, not all customers need pay the same price for the same upsell. For example, if a customer has a first purchase price of $4.64, a particular upsell may be offered in exchange for payment of a rounded price that is $5.00 ($4.64 rounded to the nearest dollar). The customer would thus pay $0.36 for the upsell. However, another customer with a second purchase price of $4.72 may be offered the same upsell for $5.00 ($4.72 rounded to the nearest dollar). Thus, this customer would pay $0.28 for the same upsell. Accordingly, the upsell is not a product that is merely on-sale and has a fixed price for every customer. Instead, the upsell is purchased for an amount that may be different for every customer: an amount necessary to round the purchase price to some rounding multiple. The rounded price need not be the next highest dollar. The rounded price may be, for example, a dollar that results in a round-up amount greater than a predetermined minimum.

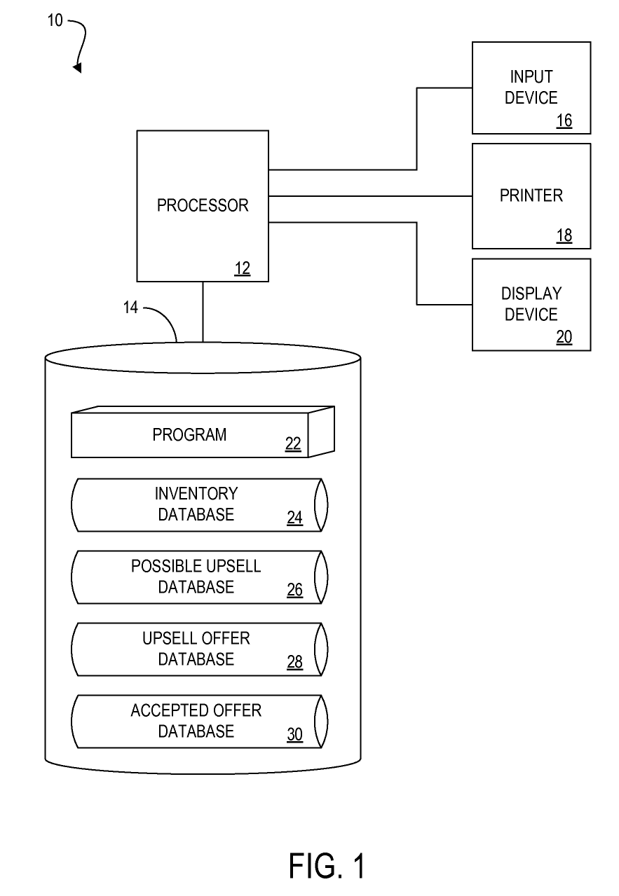

Referring to FIG. 1, a POS terminal 10 comprises a processor 12, such as one or more conventional microprocessors. The POS terminal may be, for example, the PAR Microsystems POS III or POS IV, or the IBM 4683 or IBM 4693 manufactured by International Business Machines. Alternatively, the POS terminal may comprise a remote communications device, such as a cellular telephone, Personal Digital Assistant (PDA) or web access device and/or another device, such as a web server, that interacts with the remote communication device. The processor 12 is in communication with a data storage device 14, such as an appropriate combination of magnetic, optical and/or semiconductor memory. The processor 12 and the storage device 14 may each be (i) located entirely within a single computer or other computing device; (ii) connected to each other by a remote communication medium, such as a serial port cable, telephone line or radio frequency transceiver; or (iii) a combination thereof. For example, the POS terminal 10 may comprise one or more computers that are connected to a remote server computer for maintaining databases.

An input device 16, a printer 18 and a display device 20 are each in communication with the processor 12. The input device 16 may include a keypad for transmitting input signals, such as signals representative of a purchase, to the processor 12. The input device 16 may also comprise an optical bar code scanner for reading bar codes and transmitting signals representative of those bar codes to the processor 12. The printer 18 is for registering indicia on paper or other material, thereby printing receipts and other items as commanded by the processor 12. The display device 20 is preferably a video monitor for displaying at least alphanumeric characters to the customer and/or a cashier operating the POS terminal 10. Many types of input devices, printers and display devices are known to those skilled in the art, and need not be described in detail herein.

The storage device 14 stores a program 22 for controlling the processor 12. The processor 12 performs instructions of the program 22, and thereby operates in accordance with the present invention, and particularly in accordance with the methods described in detail herein. The program 22 furthermore includes program elements that may be necessary, such as an operating system and “device drivers” for allowing the processor 12 to interface with computer peripheral devices, such as the input device 16, the printer 18 and the display device 20. Appropriate device drivers and other necessary program elements are known to those skilled in the art, and need not be described in detail herein.

The storage device 14 also stores (i) an inventory database 24; (ii) a possible upsells database 26; (iii) an upsell offer database 28; and/or (iv) an accepted offer database 30. The databases 24, 26, 28 and 30 are described in detail below and depicted with exemplary entries in the accompanying figures. As will be understood by those skilled in the art, the schematic illustrations of, and accompanying descriptions of the databases presented herein are exemplary arrangements for stored representations of information. A number of other arrangements may be employed besides the tables shown. Similarly, the illustrated entries represent exemplary information, but those skilled in the art will understand that the number and content of the entries can be different from those illustrated herein.

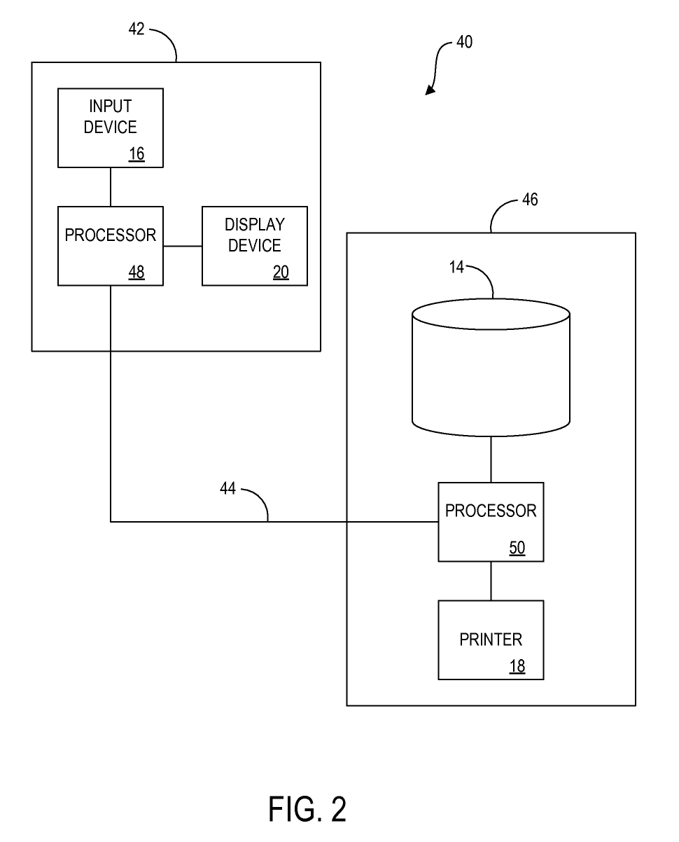

Referring to FIG. 2, another embodiment of a POS terminal 40 includes a control device 42 which is in communication via a communication medium 44 with a system 46 for printing receipts and/or coupons. The control device 42 comprises a processor 48 that is in communication with the input device 16 (FIG. 1) and the display device 20 (FIG. 1). The system 46 for printing comprises a processor 50 in communication with the storage device 14 (FIG. 1) and the printer 18 (FIG. 1). In this embodiment, the control device 42 may be a cash register, and the system 46 may be an electronic device for printing coupons in accordance with data received from the cash register. Other configurations of POS terminals will be understood by those skilled in the art.

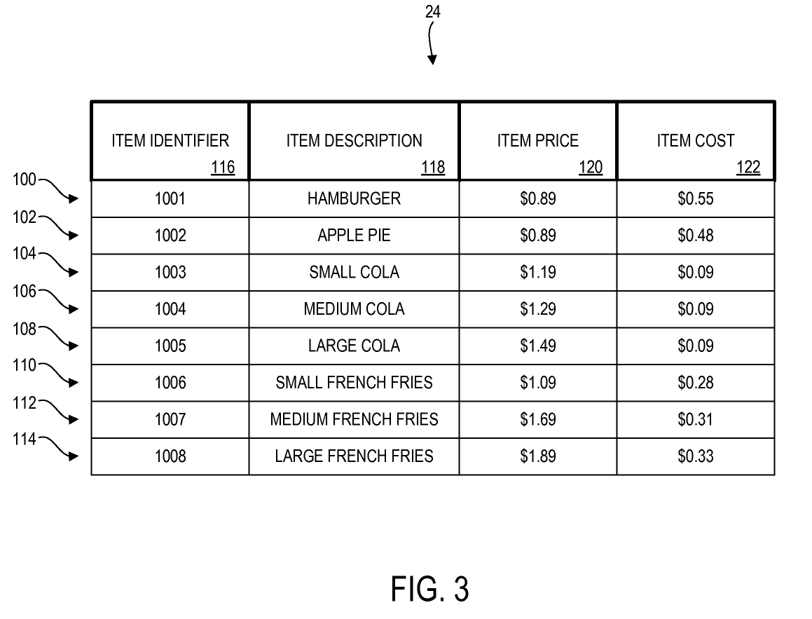

Referring to FIG. 3, the inventory database 24 of FIG. 1 includes entries 100, 102, 104, 106, 108, 110, 112 and 114, each defining an item which may be purchased. Each entry includes (i) an item identifier 116 that uniquely identifies the item; (ii) an item description 118; (iii) an item price 120; and (iv) an item cost 122. For each entry, the item price 120 indicates a price that a customer normally pays for the corresponding item, and the item cost 122 indicates a cost of the item to the business. Accordingly, the item cost 122 may be, for example, a price that the business itself pays for the item. The item cost may include various types of costs, such as variable costs, fixed costs, costs of packaging, costs of preparation, and cost of storage. In some embodiments, the inventory database 24 may also include an indication of the quantity available of each item. The cost of an item or the quantity available of an item may be a factor in determining whether the item will be stored as a possible upsell for ordered items. For example, if the cost of an item to the business increases, it may no longer be efficient for the business to offer the item as an upsell for a particular rounded price or with particular purchased items (e.g. with items whose profit margins are not large). Similarly, if an item is not available in inventory or the quantity of the item is low, that item may be removed from the upsell offer database as a possible upsell or otherwise indicated as unavailable for offering. Such an adjustment may be done automatically by the system or manually by a store manager or other authorized personnel.

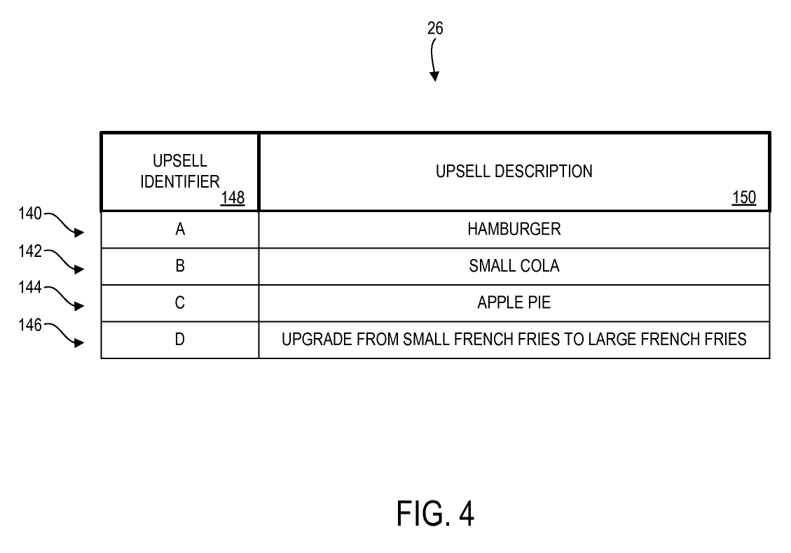

Referring to FIG. 4, the possible upsells database 26 of FIG. 1 includes entries 140, 142, 144 and 146, each defining an upsell that may be offered to a customer in exchange for change due. Each entry includes (i) an upsell identifier 148 that uniquely identifies the upsell; and (ii) an upsell description 150.

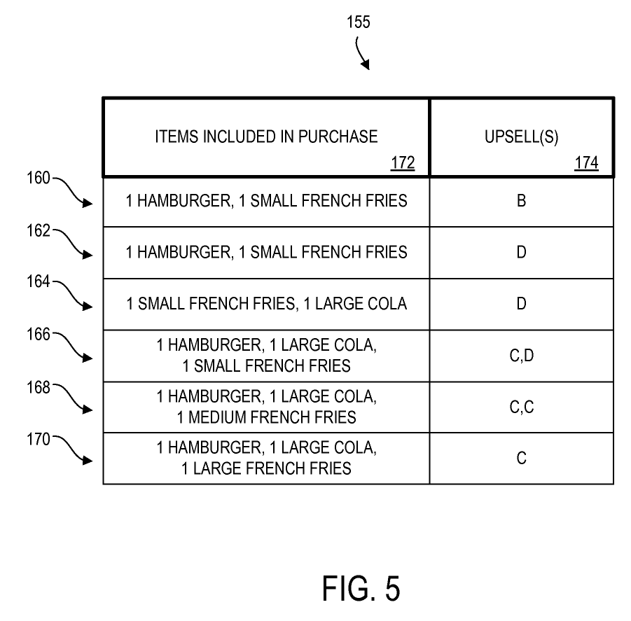

Referring to FIG. 5, a table 155 illustrates one embodiment of the upsell offer database 28 (FIG. 1). The table 155 includes entries 160, 162, 164, 166, 168 and 170, each defining upsells to offer when a customer's purchase consists of particular items. Each entry includes (i) items 172 included in the purchase; and (ii) upsells 174 to offer. For example, if a purchase consists of small French fries and a large cola, then the entry 164 indicates that the upsell “D” is to be offered. As illustrated by the entry 146 of the possible upsells database 26 (FIG. 4), the upsell “D” is an upgrade from small French fries to large French fries. Accordingly, if the customer accepted this offer, he would receive large French fries and a large cola.

The items included in a particular purchase may correspond to more than one entry of the upsell offer database 28. For example, a purchase that consists of a hamburger and small French fries corresponds to the entry 160 and to the entry 162. If a purchase corresponds to more than one entry, then one entry may be selected at random, in accordance with various selection criteria, or in accordance with direction from a cashier. The upsell(s) corresponding to the selected entry are offered to the customer. Alternatively, the customer may be allowed to select from amongst the entries, and thereby choose the upsell(s) corresponding to the selected entry.

In one embodiment, other information such as time of day, season of year, or a nearby event may be utilized as a factor in determining which of the possible upsells to offer to the customer. For example, if the possible upsells are an apple pie and an ice cream cone then the apple pie may be selected if the current month is October-April and the ice cream cone may be selected otherwise.

An entry of the upsell offer database 28 may indicate more than one upsell. For example, the entry 166 indicates that a customer purchasing a hamburger, large cola and small French fries is offered upsells “C” and “D”. Similarly, the entry 168 indicates that a customer purchasing a hamburger, a large cola and medium French fries is offered upsells “C” and “C” (two units of upsell “C”). As indicated by the entry 144 of the possible upsells database 26 (FIG. 4), the upsell “C” is an apple pie. Accordingly, if the customer accepted this offer, he would receive a hamburger, a large cola, medium French fries and two apple pies.

A rounded price that the customer pays for both the items and the upsell(s) may be determined by rounding up the purchase price to a predetermined multiple, such as to the next higher dollar amount. Alternatively, the upsell offer database 28 may indicate the rounded price, directly or indirectly, as described below.

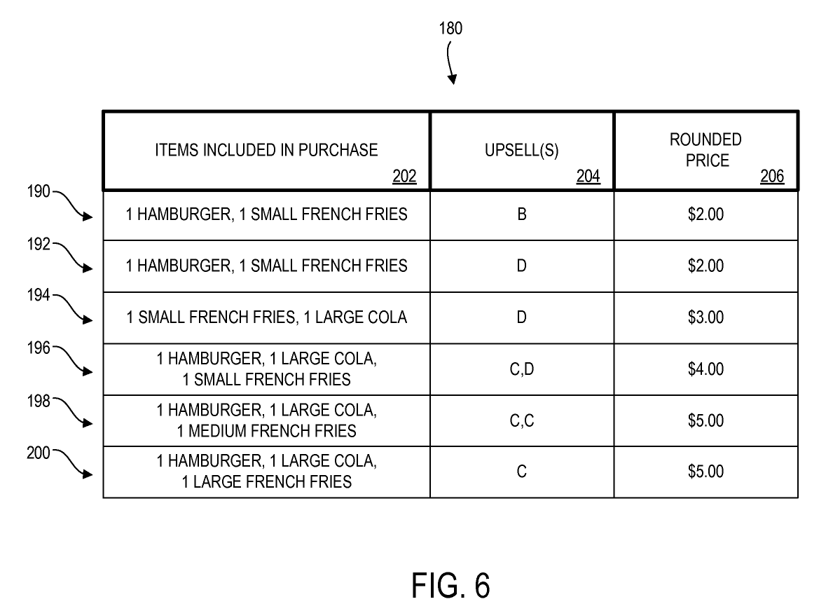

Referring to FIG. 6, a table 180 illustrates another embodiment of the upsell offer database 28 (FIG. 1). The table 180 includes entries 190, 192, 194, 196, 198 and 200, each defining upsells to offer when a customer's purchase consists of particular items. Each entry includes (i) items included in the purchase 202; (ii) upsells 204 to offer; and (iii) a rounded price 206 to charge for the items and the upsells if the customer accepts the offer. For example, if a purchase consists of a hamburger, a large cola and large French fries, and upsell “C” is offered and accepted in accordance with the entry 200, then the entry 200 also indicates that a rounded price of $5.00 is charged to the customer. Although the exemplary rounded prices depicted in FIG. 6 are each multiples of one dollar, the rounded prices may be multiples of any value, such as five dollars or twenty-five cents.

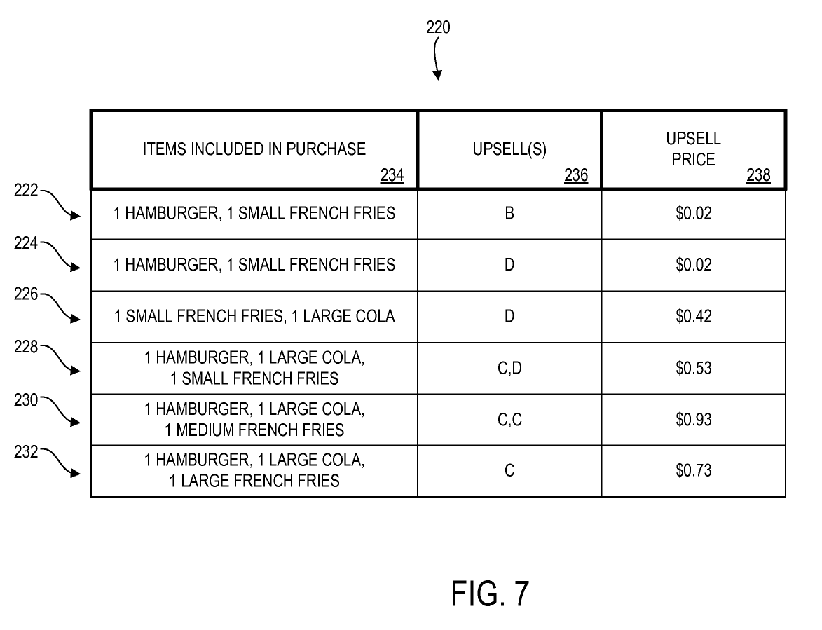

Referring to FIG. 7, a table 220 illustrates another embodiment of the upsell offer database 28 (FIG. 1). The table 220 includes entries 222, 224, 226, 228, 230 and 232, each defining upsells to offer when a customer's purchase consists of particular items. Each entry includes (i) items included in the purchase 234; (ii) upsells 236 to offer; and (iii) an upsell price 238 to be added to the purchase price if the customer accepts the offer. Preferably, the upsell prices are such that, when added to the corresponding purchase price, the resulting sum is a rounded price, such as a multiple of a dollar.

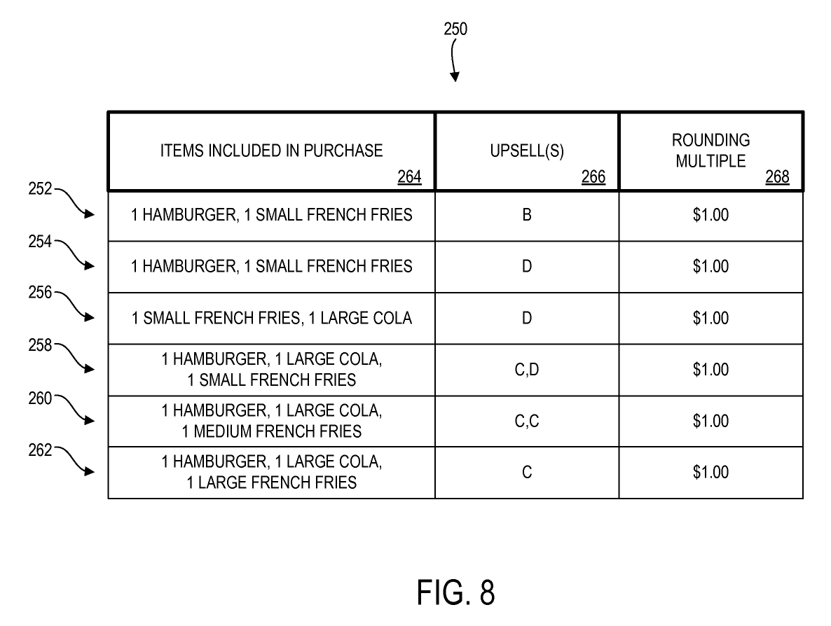

Referring to FIG. 8, a table 250 illustrates another embodiment of the upsell offer database 28 (FIG. 1). The table 250 includes entries 252, 254, 256, 258, 260 and 262, each defining upsells to offer when a customer's purchase consists of particular items. Each entry includes (i) items included in the purchase 264; (ii) upsells 266 to offer; and (iii) a rounding multiple 268 that indicates an amount to which the purchase price is rounded if the customer accepts the offer. Thus, the purchase price would be determined, and then rounded in accordance with the corresponding rounding multiple to yield a rounded price. For example, the entries 252, 254, 256, 258, 260 and 262 each define that the purchase price is rounded to the nearest dollar.

In another embodiment the upsell offer database 28 may store an upsell to offer based on at least one item purchased and an amount tendered from the customer. In such an embodiment the process of determining what upsell to offer a customer would not be initiated until the amount tendered from the customer was determined. Then, based on the amount tendered and at least one item in the customer's purchase, the upsell to offer would be determined by finding the appropriate record that corresponds to that amount tendered and the at least one purchased item in the upsell offer database.

In some embodiments, the upsell offer database or portions thereof may (but need not) be stored at the point-of-sale terminal(s) of the store. Further, different point-of-sale terminals in the store may have different upsells stored in the local databases as corresponding to the same purchased items. For example, the upsell offer database in one POS may store an apple pie as an upsell to be offered to someone that orders french fries and a hamburger, while another POS may store cookies as the upsell to be offered to someone who orders the same items. This embodiment may be helpful in preventing customers from predicting as easily what upsell they will get with their order. If a customer can accurately predict an upsell that will be offered with items ordered, he may exploit this information to pay less for a product than he otherwise would have.

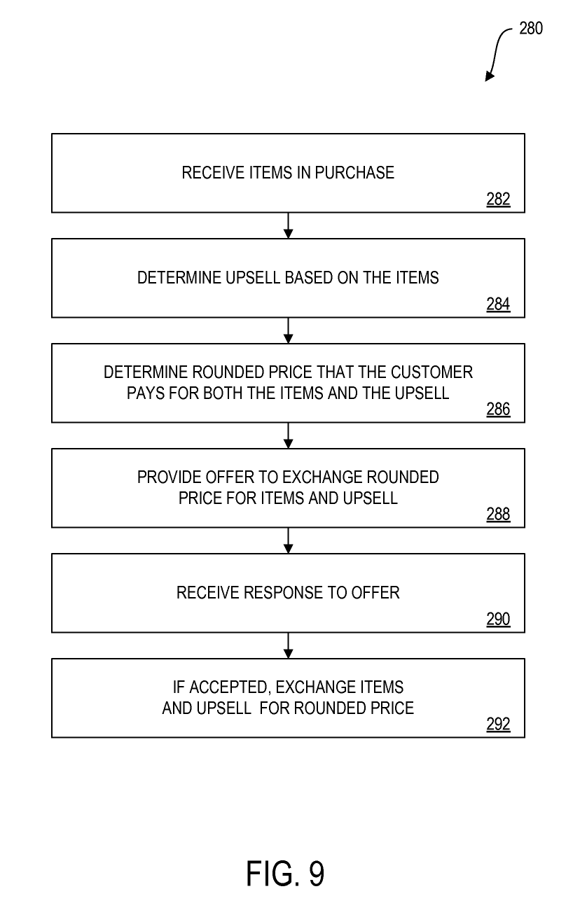

Referring to FIG. 9, a method 280 for providing a supplementary product sale at a POS terminal initiates when the POS terminal receives the items in a purchase (step 282). Typically, each item will have a bar code that is scanned by a bar code scanner, and the POS terminal in turn receives, from the bar code scanner, signals representative of the items. Alternatively, various keys of the input device 16 may be pressed by the cashier and/or customer to generate signals representative of the items. The POS terminal then determines an upsell based on the items (step 284). To determine the upsell, the POS terminal may search the upsell offer database 28 (FIG. 1) in order to determine one or more records that correspond to the items, and thereby determine the corresponding upsells of those records. In one embodiment of the present invention, the method 280 may only be initiated if authorized cashiers are operating the POS terminal. For example, only certain cashiers may be authorized to offer upsells to customers. This may be, for example, because the store wants to ensure that the upsells are offered accurately and effectively to customers and thus requires that cashiers first train and qualify for the authorization to offer upsells. In such an embodiment, the POS terminal may first determine the cashier identifier of the cashier currently operating the POS terminal and only initiate method 280 if the cashier is an authorized cashier.

The POS terminal determines a rounded price that the customer may pay for both the items and the upsell(s) (step 286). As described above, the rounded price may be determined by rounding up the purchase price to a predetermined multiple, such as to the next higher dollar amount. In other embodiments, the rounded price is determined from the upsell offer database. In one embodiment, the rounded price may be determined based on a record of the upsell offer database. For example, as described above with respect to FIG. 6, each entry of the upsell offer database may include the rounded price. In another embodiment, as described above with respect to FIG. 7, each entry of the upsell offer database may include a rounding multiple, and the purchase price is rounded in accordance with the rounding multiple to thereby generate the rounded price. In still another embodiment, as described above with respect to FIG. 8, each entry of the upsell offer database may include an upsell price that is added to the purchase price to thereby generate the rounded price.

The customer is provided with an offer to exchange (purchase) the items and the upsell(s) for the rounded price (step 288). For example, the POS terminal may output an indication of the upsell(s), such as the name of the upsell(s), on the display device 20 (FIG. 1). If the customer accepts the offer, a required payment amount is set to be the rounded price. This required payment amount is an amount of money expected to be paid in return for products provided to the customer. From the required payment amount, the processor 12 (FIG. 1) may determine, for example, the total amount of money that should have been collected by the POS terminal at the end of a day. Those skilled in the art will note that the required payment amount is typically stored on the data storage device 14, and may comprise, for example, a single stored value for the transaction or a plurality of values which each correspond to an amount of money expected to be paid for one or more products in the transaction. Such information is typically useful in assuring that payment received from the customer is accounted for.

The customer responds to the offer, and the response is received by the POS terminal when a key on the input device 16 is pressed, or in other manners known to those skilled in the art (step 290). If the response indicates acceptance of the offer, the items and the upsell(s) are exchanged for the rounded price (step 292). If desired, the POS terminal makes appropriate adjustments to stored indications of available quantities of items to reflect that the items and upsell(s) have been sold. The POS terminal may also store the response to the offer for accounting and marketing analysis.

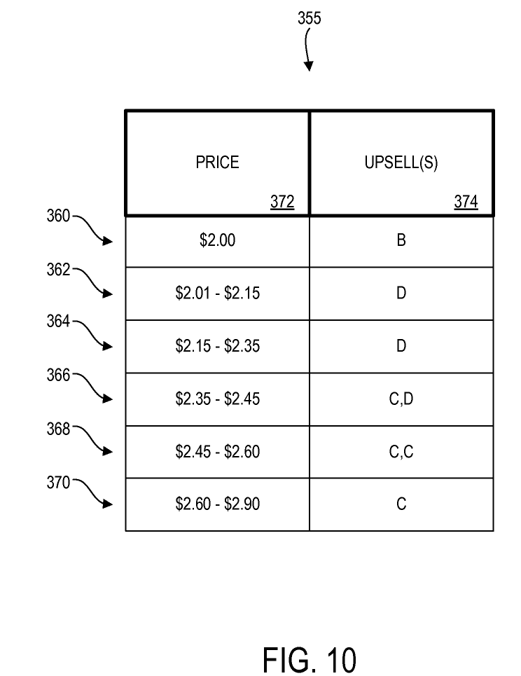

Referring to FIG. 10, a table 355 illustrates another embodiment of the upsell offer database 28 (FIG. 1). The table 355 is similar to the table 155 of FIG. 5, but the purchase price, rather than the items included in the purchase, define the upsell to offer. The features and uses of the table 155 of FIG. 5 are applicable to the table 355.

The table 355 includes entries 360, 362, 364, 366, 368 and 370, each defining upsells to offer when a customer's purchase price is a particular amount or within a particular range of amounts. Each entry includes (i) purchase price 372; and (ii) upsells 374 to offer. For example, if a purchase price is $2.22, then the entry 364 indicates that the upsell “D” is to be offered. As illustrated by the entry 146 of the possible upsells database 26 (FIG. 4), the upsell “D” is an upgrade from small French fries to large French fries. Accordingly, if the customer accepted this offer, he would receive large French fries if he had ordered small French fries. If he had not ordered small French fries, this upsell offer could be ignored, possibly in favor of another possible upsell.

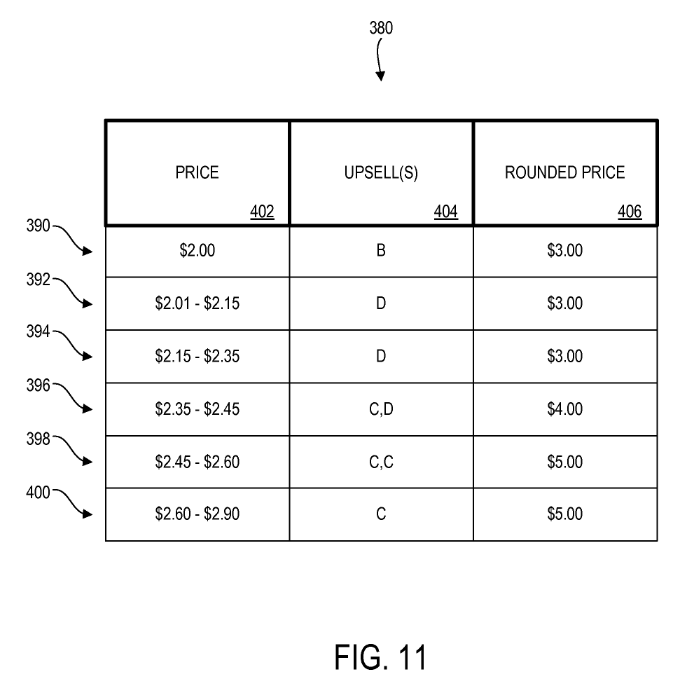

Referring to FIG. 11, a table 380 illustrates another embodiment of the upsell offer database 28 (FIG. 1). The table 380 is similar to the table 180 of FIG. 6, but the purchase price, rather than the items included in the purchase, define the upsell to offer. The features and uses of the table 180 of FIG. 6 are applicable to the table 380.

The table 380 includes entries 390, 392, 394, 396, 398 and 400, each defining upsells to offer when a customer's purchase price is a particular amount or within a particular range of amounts. Each entry includes (i) purchase price 402; (ii) upsells 404 to offer; and (iii) a rounded price 406 to charge for the items and the upsells if the customer accepts the offer. For example, if a purchase price is $2.65, and upsell “C” is offered and accepted in accordance with the entry 400, then the entry 400 also indicates that a rounded price of $5.00 is charged to the customer. Although the exemplary rounded prices depicted in FIG. 11 are each multiples of one dollar, the rounded prices may be multiples of any value, such as five dollars or twenty-five cents.

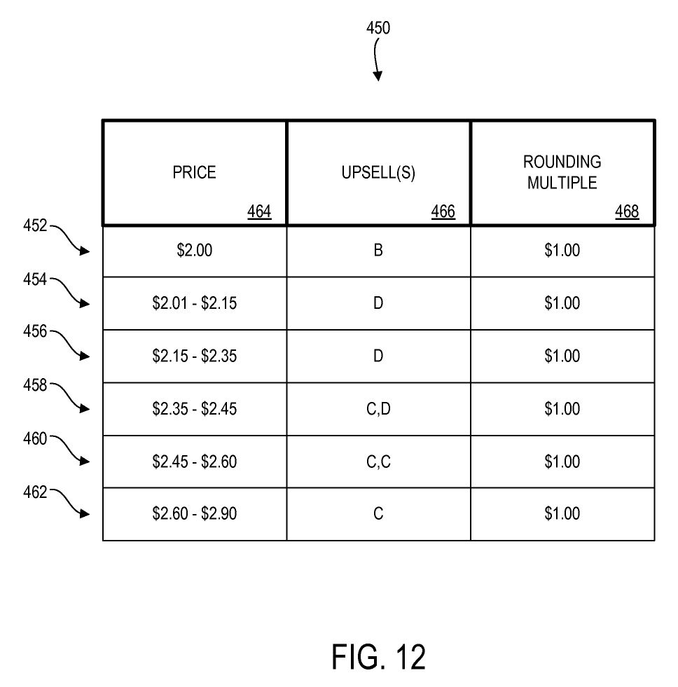

Referring to FIG. 12, a table 450 illustrates another embodiment of the upsell offer database 28 (FIG. 1). The table 450 is similar to the table 250 of FIG. 8, but the purchase price, rather than the items included in the purchase, define the upsell to offer. The features and uses of the table 250 of FIG. 8 are applicable to the table 450.

The table 450 includes entries 452, 454, 456, 458, 460 and 462, each defining upsells to offer when a customer's purchase price is a particular amount or within a particular range of amounts. Each entry includes (i) purchase price 464; (ii) upsells 466 to offer; and (iii) a rounding multiple 468 that indicates an amount to which the purchase price is rounded if the customer accepts the offer. Thus, the purchase price would be determined, and then rounded in accordance with the corresponding rounding multiple to yield a rounded price. For example, the entries 452, 454, 456, 458, 460 and 462 each define that the purchase price is rounded to the nearest dollar.

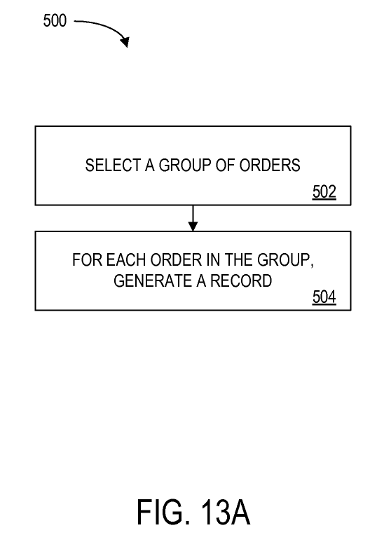

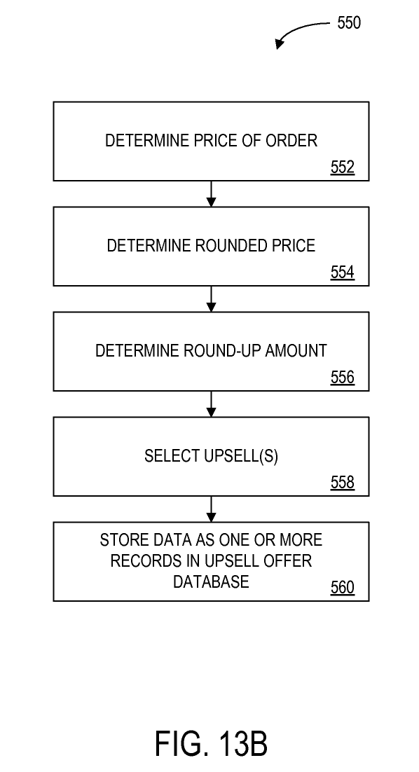

Referring to FIG. 13A, a method 500 for generating data for use in a supplementary product sale is used to generate data such as the data in an upsell offer database. A group of orders is selected (step 502). For example, all possible orders may be generated, all commonly-occurring orders (e.g., upon review of orders placed during the last month) or any other desired set of orders. For each order in that group, a record is generated (step 504), such as a record of an upsell offer database.

Referring to FIG. 13B, a method 550 for generating data for use in a supplementary product sale depicts the generation of a record of an upsell offer database for an order. The record may be a record that indicates items included in the purchase (e.g., entries of table 155 of FIG. 5) or that indicates a purchase price (e.g., entries of table 355 of FIG. 10). A price of the order is determined (step 552). For example, the individual prices of the items in a purchase may be summed. A rounded price is then determined based on any of a number of criteria (step 554). For example, in one embodiment the purchase price may be rounded up to the next dollar. A round-up amount based on the rounded price is then determined (step 556), and an upsell is selected (step 558).

Many methods for determining a rounded price and/or an upsell for an order are disclosed in commonly owned U.S. patent applications and U.S. patents, including U.S. Pat. No. 6,119,099 to Walker et al.; U.S. Pat. No. 6,223,163 to Van Luchene; U.S. Pat. No. 6,267,670 entitled SYSTEM AND METHOD FOR PERFORMING LOTTERY TICKET TRANSACTIONS UTILIZING POINT-OF-SALE TERMINALS; U.S. patent application Ser. No. 09/045,036, entitled METHOD AND APPARATUS FOR FACILITATING THE PLAY OF FRACTIONAL LOTTERY TICKETS UTILIZING POINT-OF-SALE TERMINALS; U.S. patent application Ser. No. 09/045,347 entitled METHOD AND APPARATUS FOR PROVIDING A SUPPLEMENTARY PRODUCT SALE AT A POINT-OF-SALE TERMINAL, U.S. patent application Ser. No. 09/045,386, entitled METHOD AND APPARATUS FOR CONTROLLING THE PERFORMANCE OF A SUPPLEMENTARY PROCESS AT A POINT-OF-SALE TERMINAL; U.S. Pat. No. 7,072,850 entitled METHOD AND APPARATUS FOR PROCESSING A SUPPLEMENTARY PRODUCT SALE AT A POINT-OF-SALE TERMINAL; U.S. Pat. No. 6,298,329 entitled METHOD AND APPARATUS FOR GENERATING A COUPON; U.S. Pat. No. 6,298,331 entitled METHOD AND APPARATUS FOR SELLING AN AGING FOOD PRODUCT; U.S. patent application Ser. No. 09/083,689, entitled METHOD AND SYSTEM FOR SELLING SUPPLEMENTAL PRODUCTS AT A POINT-OF-SALE; U.S. patent application Ser. No. 09/603,677, entitled METHOD AND APPARATUS FOR SELECTING A SUPPLEMENTAL PRODUCT TO OFFER FOR SALE DURING A TRANSACTION; and U.S. patent application Ser. No. 09/777,297, entitled METHOD AND APPARATUS FOR CONTROLLING OFFERS THAT ARE PROVIDED AT A POINT-OF-SALE TERMINAL.

Some or all of the data generated by the steps of the method 550 may be stored as one or more records of an upsell offer database. For example, data representing items included in the order and upsells to offer may be stored to create a record appropriate for table 155 (FIG. 5). Further data may be stored in the record, such as the weight to give to an upsell so that its preference may be compared to other upsells that may be offered in response to a particular order. The profit margin of a particular upsell for a particular order, rounded price and/or round-up amount may also be stored in the record, allowing a comparison of the profitability of different upsells for various orders.

The methods 500 and 550 may be performed by any number of devices. For example, the methods 500 and 550 may be performed by a device that is not in communication with a POS terminal, such as a personal computer or workstation that is not involved in managing POS terminals operations. Alternatively, the methods 500 and 550 may be performed by a device that is in communication with a POS terminal, such as a server that manages the operations of a plurality of POS terminals. Furthermore, the methods 500 and 550 may be performed by a POS terminal. Still other devices may perform the methods 500 and 550.

The data may be generated by the methods 500 and 550 and repeatedly copied. For example, once such data is generated it may be installed in an upsell offer database on a POS terminal or on a server communicating with one or more POS terminals. Such data could also be repeatedly copied and installed in a plurality of upsell offer databases for use, e.g., by POS terminals of different companies or franchises.

The present invention is also applicable to the drive-thru environment. Customer at a drive-thru window of a quick service restaurant may be offered upsells that correspond to items they have ordered. In drive-thru windows that are equipped with a screen on which the customer's order may be displayed to the customer for confirmation, the upsell or upsells being offered may also be displayed to the customer as the offer is being made.

Although the present invention has been described with respect to a preferred embodiment thereof, those skilled in the art will note that various substitutions may be made to those embodiments described herein without departing from the spirit and scope of the present invention. For example, although reference has been made to a customer located at or near a quick service restaurant, the present invention may be utilized by a customer that remotely orders items. In such an embodiment, a customer may order items using, e.g., a computer with access to the world wide web. The computer allows access to a web site where the customer orders items, e.g., for delivery or pick up.

What is claimed is:

1. A method comprising:
receiving key presses that are representative of a plurality of items, the plurality of items defining a purchase price;
determining a record in a database that corresponds to at least one of the items, the record specifying a corresponding upsell and an upsell price;
receiving a key press that indicates acceptance of the offer; and
selling the items and the upsell for the rounded price.

2. A system comprising:
a storage means for storing a database including records, each record storing an indication of at least one upsell corresponding to a purchased item, wherein the at least one upsell comprises an upsell that may be offered to a customer in exchange for a rounded price;
a means for enabling personnel authorized to determine upsells to access the records in order to adjust the at least one upsell corresponding to the purchased item; and
a plurality of point-of-sale terminals, each in communication with the storage means and operated by personnel not authorized to determine upsells, wherein the plurality of point-of-sale terminals are operable to determine an upsell to offer to a customer based on a record.

3. A method for determining a supplemental product to offer to a customer, comprising:
receiving a request to make an adjustment to a database containing records of upsells to offer to a customer in exchange for a rounded amount, wherein each of the upsells corresponds to at least one purchased item;
receiving an authorization code;
determining whether the authorization code permits the adjustment requested;
and
implementing the adjustment if the authorization code permits the adjustment such that subsequent requests for upsells from point of sale terminals will be processed in accordance with the adjustment.

4. A method for determining a supplemental product to offer to a customer, comprising:
receiving an indication of at least one purchased item included in a purchase;
receiving an indication of an amount tendered for the purchase;
accessing a database record based on the at least one purchased item and the amount tendered;
determining an upsell to offer to a customer; and
causing the upsell to be offered to the customer in conjunction with the at least one purchased item in exchange for the amount tendered.

5. A method for generating data for use in a supplemental product offer, the method comprising:
determining a round-up amount for a purchase based on a purchase price of the purchase;
determining an upsell for the purchase based on the round-up amount;
storing in a record an indication of
the purchase price, and
the upsell; and
using the record to provide an offer for the upsell.

6. A computer-readable medium that stores a record created in accordance with the method of claim 5.

7. A computer-readable medium that stores data accessible by a program, the program being executable on a data processing system, the data being organized according to a data structure that includes
a first data object defining a purchase price of a purchase; and
a second data object defining an upsell to offer, the second data object being accessible from the first data object.

8. A method comprising:
receiving key presses that are representative of a plurality of items, the plurality of items defining a purchase price;
determining a record in a database that corresponds to at least one of the items, the record specifying a corresponding upsell and an upsell price;
generating a rounded rice based on the purchase price and the upsell price;
displaying an indication of the upsell and the rounded price;
receiving a key press that indicates acceptance of the offer; and
selling the items and the upsell for the rounded price.
